(19) United States
(12) Patent Application Publication
(10) Pub. No.: US 2017/0098230 A1
(43) Pub. Date: Apr. 6, 2017

(54) AIR FILTERS, AND ELECTRONIC MECHANICAL RECORDS AND NOTIFICATIONS REGARDING SAME.

(71) Applicant: MAT ORANGKHADIVI, KANSAS CITY, MO (US)

(72) Inventor: MAT ORANGKHADIVI, KANSAS CITY, MO (US)

(21) Appl. No.: 15/284,448

(22) Filed: Oct. 3, 2016

Related U.S. Application Data
(60) Provisional application No. 62/236,379, filed on Oct. 2, 2015.

(51) Int. Cl. G06Q 30/02; G06Q 10/08; G06K 19/06; B01D 46/00; G06K 7/10

(52) U.S. Cl. CPC G06Q 30/0206; B01D 46/008; G06K 7/10554; G06K 19/06037; G06Q 10/083; B01D 2279/50

(57) ABSTRACT

A method for ensuring timely replacement of an air filter in a building comprises the step of using a testing device to obtain an indoor air quality measurement and the step of employing the indoor air quality measurement to determine a preferred air filter. A barcode is situated at a booth of the air filter. The barcode is inaccessible when the booth is in a closed position. The booth is opened to expose the barcode, and the barcode is scanned using a scanner prior to replacing the air filter with the preferred air filter. Data indicating the replacement of the air filter is received over a network. The data includes at least a date of the scan. The scan date is stored in a database and computer implemented instructions are used to determine a shipment date based on the scan date.

### CROSS REFERENCE TO RELATED APPLICATIONS

This application claims priority to U.S. Provisional Patent Application Ser. No. 62/236,379 filed Oct. 2, 2015, the disclosure of which is incorporated herein by reference in its entirety.

### FIELD OF THE INVENTION

The invention relates generally to the field of electronic mechanical records and notifications for consumables. More specifically, the invention relates to systems and methods for providing electronic records and notifications associated with air filters and their appropriate selection and timely replacement.

### SUMMARY

Systems and methods for selecting optimal filters and ensuring their timely replacement are disclosed herein. According to an embodiment, a method for ensuring timely replacement of an air filter in a building comprises the step of using a testing device to obtain an indoor air quality measurement and the step of employing the indoor air quality measurement to determine a preferred air filter. A barcode is situated at a booth of the air filter. The barcode is inaccessible when the booth is in a closed position. The booth is opened to expose the barcode, and the barcode is scanned using a scanner prior to replacing the air filter with the preferred air filter. Data indicating the replacement of the air filter is received over a network. The data includes at least a date of the scan. The scan date is stored in a database and computer implemented instructions are used to determine a shipment date based on the scan date.

According to another embodiment, a method for facilitating timely replacement of a first air filter with a second air filter comprises the step of situating at an air filter booth a barcode. The air filter booth is associated with a building. The barcode is scanned using a scanner when replacing the first air filter with the second air filter. Data indicating the replacement of the first air filter is received over a network and stored in a database. The data in the database is used to ship to the building a replacement air filter before the second air filter is past its useful life.

According to yet another embodiment, a system for facilitating timely replacement of an air filter through an online structure comprises a processor and a filter assessor module for evaluating an indoor air quality measurement to determine a suggested filter. The system has an application programming interface for communicating with a mobile computer. The mobile computer has a barcode scanner for scanning a barcode. The system includes a fulfillment database. The fulfillment database is updated when the mobile computer communicates a date of the scan to the system.

### BRIEF DESCRIPTION OF THE DRAWINGS

Illustrative embodiments of the present invention are described in detail below with reference to the attached drawing figures and wherein:

FIG. 1 is a schematic illustration of an electronic mechanical record and notification system, according to an example embodiment.

FIG. 2 shows example contents of an indoor air quality measurements database of the system of FIG. 1.

FIG. 3 is a schematic illustration of a testing device for use with the system of FIG. 1.

FIG. 4 shows example contents of an economic forecast model generated by the system of FIG. 1.

FIG. 5 shows example contents of an outdoor air quality measurements database of the system of FIG. 1.

FIG. 6 schematically illustrates contents of an air filter map database of the system of FIG. 1.

FIG. 7 shows example contents of a fulfillment database of the system of FIG. 1.

FIG. 8A shows a side view of an air filter booth in a closed position.

FIG. 8B shows a side view of the air filter booth of FIG. 8A after it has been opened and an air filter therein has been moved to expose a barcode placed within the booth.

FIG. 9 shows a flowchart outlining an example method of using the system of FIG. 1 to select an optimal filter and to facilitate timely replacement thereof.

### DETAILED DESCRIPTION

Consumables, i.e., products that deplete over time and must or should be replaced (or maintained, e.g., require upkeep) periodically, are ubiquitous. The ink cartridges in a printer, for example, may eventually run out of ink and may need to be replaced or replenished from time to time to ensure that the printer functions as intended. The engine oil in a vehicle may wear and break down over time and may need to be replaced periodically to facilitate proper operation of the vehicle. Light bulbs in a light fixture may go out over time and may need to be replaced to ensure that the light fixture functions as desired, and so on.

The time after which a consumable needs to be replaced (or maintained) may depend on use. For example, an ink cartridge in a printer that sees heavy use may need to be replaced every month, whereas an ink cartridge in a printer that is not used often may last for several months. The engine oil in a vehicle that is tracked may need to be replaced every week, while the engine oil in a vehicle that is used only on city streets may last several months. Light bulbs in a fixture that is constantly powered may run out before light bulbs in a fixture that is turned on only on weekends, and so forth.

In addition to use, other factors may affect the time period after which a particular consumable must or should be replaced or maintained. For example, the environment in which a consumable is employed may, in certain situations, have an impact on this time period. For instance, a barber may be required to replace the blade on a shaving razor after each use, whereas at home, the same blade may be reused multiple times. A hotel may have to replace a bar of soap in a restroom every day, while at home, that bar of soap may be reused until it is depleted.

Some consumables must be replaced after a certain time period because they, or the systems of which they are a part, cease to function after the time period. An ink cartridge in a printer, for instance, is an example of a consumable that must be replaced when the ink runs out. If the ink cartridge is not replaced when the ink is exhausted, the printer cannot function. Therefore, there is little risk that the user will continue to operate the printer when the consumable (i.e., ink in this example) has been depleted. Replacement of other consumables, however, is not an absolute requirement, because they (and/or the systems of which they are a part) continue to function after the time period, albeit in a reduced capacity. Engine oil in vehicles is an example of such a consumable, because the vehicle generally remains operable even if the engine oil is not changed after the recommended time period (e.g., 3 months). But, if the engine oil is not replaced after the recommended time period, it may get dirty and break down, which may adversely affect the performance and overall life of the vehicle. Even so, the consumer may neglect to change the engine oil in his vehicle in a timely fashion because, at least in the short term, the vehicle may continue to operate despite the consumer's failure to replace the engine oil on time.

Heating, ventilating, and air conditioning (“HVAC”) systems, which are configured to provide environmental comfort and sustenance, are abundant. A residential building unit (e.g., a house, or an apartment in an apartment building) may have a solitary HVAC system designed to provide environmental comfort to the residents of the unit (such as by regulating the temperature within the unit). A commercial building may have several HVAC systems. For example, a multi-story commercial building may include one or more HVAC systems to service each floor of the building, or to service disparate areas on each floor. HVAC systems generally account for a large percentage of the total cost of utilities for both residential and commercial buildings. For example, according to some estimates, HVAC systems account for about 50% of the electricity used in commercial buildings. As is known in the art, each HVAC system may have one or more air filters—another example consumable—associated therewith. The present disclosure, among other things, relates to systems and methods to facilitate appropriate selection and timely replacement of this consumable based on certain criteria unique to air filters.

An air filter removes (or reduces the level of) particulates such as dust, pollen, mold, pet dander, carpet and other fibers, allergens, bacteria, et cetera, from the air, and thereby improves air quality. Traditionally, air filters were made of or comprised cotton, though more recently, synthetic materials such as fiberglass, polyester, paper, et cetera, are used in the construction of air filters. In addition to cleaning the air, air filters safeguard the HVAC system with which they are associated.

The skilled artisan appreciates that air filters are of various types and come in various sizes. Some air filters may be more adept at removing particulates from the air than others. The efficiency of an air filter is often categorized using a Minimum Efficiency Reporting Value (or “MERV”) rating, which rating standard was developed by the American Society of Heating, Refrigerating, and Air Conditioning in the late 1980s. The MERV rating of an air filter typically spans from about 1 to 20 and depends on its fractional particle size efficiency. Filters having a MERV rating of between 14 and 20 are referred to in the art as HEPA filters. HEPA was invented in World War II as it filters 99.997% of air particulates and the government needed a way to remove any nuclear or radioactive material from the air. Today, HEPA filters are mandated by many facilities, such as hospitals, to remove the risk of airborne bacteria spreading around the hospital.

While an air filter with a high MERV rating removes more particulates from the air as compared to an air filter with a lower MERV rating, an air filter with a high MERV rating (e.g., a MERV rating of 20) may be unsuitable for every application because its comparatively smaller pores create much resistance in the airflow, and consequently, adversely affect the efficiency of the HVAC system. Filters having a MERV rating of around 7-13 are generally sufficient for most residential and commercial applications. Of course, filters having a different MERV rating may also be employed depending on the particular application (e.g., a filter with a higher MERV rating may be used in a household that has several pets, or where the residents are allergic to dust or pollen).

An HVAC manufacturer or operator will generally recommend that an air filter be replaced regularly (e.g., monthly, every two months, every three months, et cetera). As time goes on, more and more particulate matter is absorbed by the air filter, and the pores of the filter through which the air passes become smaller and are eventually clogged. This causes the HVAC system to work harder to circulate the air and maintain the desired environmental temperature. The efficiency of the HVAC system is thus adversely affected, which translates into higher utility costs. Studies indicate that regularly reducing an air filter reduces the energy consumption of an HVAC system by up to fifteen percent. Further, in many cases, filters that are past their useful life cause the HVAC system to operate outside its normal operating parameters, which, in-turn, permanently damages the HVAC system thereby necessitating expensive repairs. It is thus desirable to replace air filters associated with an HVAC system in a timely fashion as this improves both the efficiency and the longevity of the HVAC system.

The duration for which an air filter performs optimally may depend on one or more of several factors, and may vary filter to filter and from one application to another. For example, a filter with a MERV rating of 11 may need to be replaced every month, whereas a filter with a MERV rating of 8 may need to be replaced every two months. Similarly, a filter with a MERV rating of 10 may need to be replaced more often as compared to another filter with the same MERV rating because the constituents of the two filters vary. Indeed, two generally identical air filters having the same MERV rating and manufactured by the same manufacturer may also need to be replaced after varying durations because of the differing environments in which the HVAC systems associated with these filters are located.

While every user of an HVAC system may not appreciate all the details of the particular air filter(s) employed, each user typically understands that the air filters associated with an HVAC system should be timely replaced. Despite this knowledge, both in residential and commercial settings, the timely replacement of air filters is often neglected and even ignored. Part of the problem arises because the end user does not have on hand a replacement air filter when it is time to replace the old air filter. Further, even users that have replacement air filters on hand may fail to timely replace the old air filter because most users do not maintain a log of when they replaced an air filter last and do not set reminders to remind them that it is time to replace the old air filter. The present disclosure may, among other things, address this and other related problems.

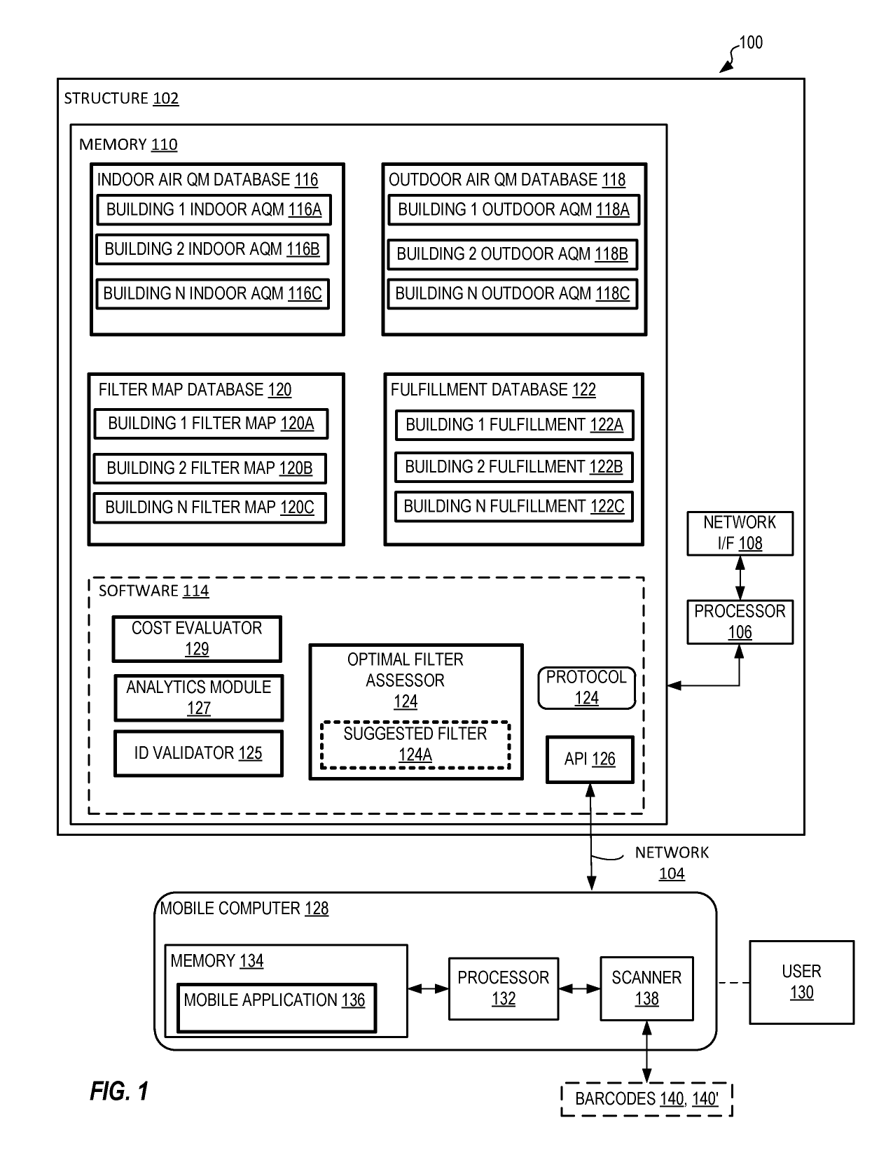

Attention is directed now to FIG. 1, which shows an embodiment 100 of an electronic mechanical record and notification system that facilitates appropriate selection and timely replacement of air filters through an online structure 102. Online structure 102 may be implemented by one or more networked computer servers, and is shown with a processor 106 communicatively coupled to a network interface 108 and a memory 110. Processor 106 represents one or more digital processors. Network interface 108 may be implemented as one or both of a wired network interface and a wireless network interface, as is known in the art. Memory 110 represents one or more of volatile memory (e.g., RAM) and non-volatile memory (e.g., ROM, FLASH, magnetic media, optical media, et cetera). Although shown within structure 102, memory 110 may be, at least in part, implemented as network storage that is external to structure 102 and accessed via network interface 108. For example, all or part of memory 110 may be stored on the “cloud” and accessed over the web by authorized personnel.

Software 114 may be stored within a transitory or non-transitory portion of the memory 110. Software 114 includes machine readable instructions that are executed by processor 106 to perform the functionality of structure 102 as described herein.

The memory 110 may also include one or more of an indoor air quality measurements database 116, an outdoor air quality measurements database 118, a filter map database 120, and a fulfillment database 122. The indoor air quality measurements database 116 may include indoor air quality measurements for various (i.e., N) buildings, such a building 1, a building 2, a building 3, and so on. The term building, as employed herein, refers to any structure that includes or has associated therewith one or more HVAC systems, such as a house, a retail store, a hospital, an office building, et cetera. Indoor air quality measurements database 116 is illustratively shown as including indoor air quality measurements 116A, indoor air quality measurements 116B, and indoor air quality measurements 116C for building 1, building 2, and building N, respectively, as discussed in more detail herein. The outdoor air quality measurements database 118, the filter map database 120, and the fulfillment database 122 may likewise comprise outdoor air quality measurements, filter map data, and fulfillment records for the N buildings, as discussed below. Specifically, the outdoor air quality measurements database 118 may include outdoor air quality measurements 118A, 118B, and 118C for buildings 1, 2, and N, respectively; the filter map database 120 may include filter map information 120A, 120B, and 120C for buildings 1, 2, and N, respectively; and the fulfillment database 122 may include fulfillment records 122A, 122B, and 122C for buildings 1, 2, and N, respectively. In some embodiments, one or more of these database 116-122 may be omitted and/or combined.

The online structure 102, using protocol 124 and Application Programming Interface 126, may communicate over a wired or wireless network 104 with a computer 128 of a user 130. Network 104, which is formed in part by one or more of the Internet, wireless networks (e.g., Bluetooth, RFID, and WiFi), wired networks, local networks, and so on, facilitates communication between the structure 102 and the computer 128.

The user computer 128 has a processor 132 and a memory 134. Processor 132 represents one or more digital processors, and memory 134 represents one or more of volatile memory (e.g., RAM) and non-volatile memory (e.g., ROM, FLASH, magnetic media, optical media, and so on). Memory 134 may, in embodiments, be external to the computer 128 and be accessed by the computer 128 over a network. In one embodiment, computer 128 is a mobile computer, such as a laptop, notebook, tablet, smartphone, et cetera, that is used by the user 130. In another embodiment, computer 128 is a stationary computer, such as a desktop computer. In a currently preferred embodiment, the computer 128 is a mobile computer, such as a smart phone.

The user 130 may download a mobile application 136 onto computer 128 that enables computer 128 to communicate with the structure 102 via Application Programming Interface 126. The application 136 is software stored in a transitory or non-transitory portion of memory 134, and includes machine readable instructions that are executed by processor 132 to improve functionality of computer 128 and to allow communication with structure 102.

The mobile computer 128 may include a scanner 138. While the scanner 138 is shown in FIG. 1 as being part of the mobile computer 128, it is contemplated that in some embodiments the scanner 138 will be external to the mobile computer 128 and be in data communication therewith. The scanner 138 may be configured to read barcodes, such as the barcodes 140 and 140′. The barcodes 140, 140′ may be any type of barcodes whether now known or subsequently developed. For example, in some embodiments, the barcodes 140 and/or 140′ may be a typical one-dimensional alpha-numeric barcode (e.g., a UPC barcode, a code 128 barcode, an ITF barcode, et cetera). In other embodiments, the barcode 140 and/or 140′ may be a static or dynamic two-dimensional barcode (e.g., a pdf 417 code, a datamatrix barcode, et cetera). In some embodiments, a two-dimensional static or dynamic quick response (“QR”) code that is readable by a smart phone or other similar electronic device may be employed. The skilled artisan appreciates that the barcodes 140 and 140′ contain information that may be accessed by scanning the barcode using the scanner 138 (e.g., an optical scanner). As discussed herein, the barcodes 140 and/or 140′ may contain pertinent information regarding an air filter, such as one or more of its type, manufacturer, dimensions, optimal duration, date of installation, location, cost, et cetera.

FIG. 1 shows that the structure 102 is in communication with a solitary user mobile computer 128. Those skilled in the art, however, will appreciate from the disclosure herein that the structure 102 may likewise be configured to communicate with computers of multiple users 130 (e.g., hundreds of different users residing in various parts of the country). The user 130 may be, for example, an HVAC technician or other person authorized to access the structure 102 via the mobile computer 128. While not expressly shown, the mobile computer 128 and the structure 102 may each include or have associated therewith input and output devices (e.g., a keyboard, a mouse, a touch screen, a display, et cetera) to allow interaction with same. While not expressly shown in FIG. 1, in some embodiments, the structure 102 may also be configured to communicate with a computer (e.g., a smart phone, laptop, desktop, et cetera) of an owner or operator of a building (e.g., building 1).

In some embodiments, the software 114 may include an identification validator 125, which may ensure that the user 130 communicating with the structure 102 via the mobile computer 128 (or another person, e.g., building 1 owner or operator communicating with the structure 102 with his computer) is an authorized user. For example, in some embodiments, the structure 102 (and specifically the memory 110) may include a unique device identification number (e.g., a Universal Device Identification Number, an Android ID, a Google Advertising ID) associated with the mobile computer 128 (and the unique device identification numbers associated with computers of the other authorized users). The software 114 may validate the identity of the user 130 during a communication session by verifying the device identification number. Alternately or in addition, in some embodiments, the user 130 may have to enter a unique password (or other information unique to the user 130, such as a thumbprint) in order to access the structure 102.

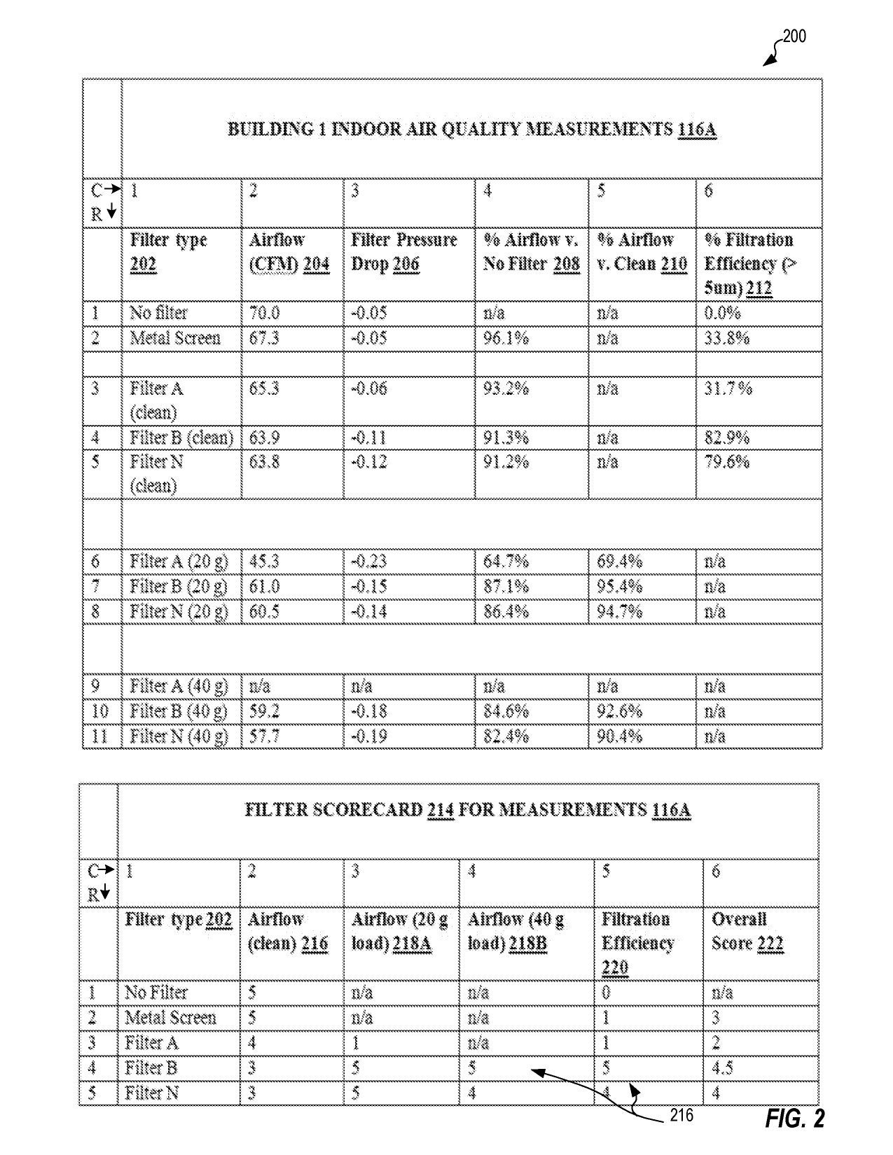

The workings of the system 100 will now be illustrated. Assume, for example, that building 1 is a bakery in Kansas and has at least one HVAC system having an air filter A. FIG. 2 shows the indoor air quality measurements 116A for the bakery 1. The artisan will understand that the building 1, and the data associated therewith as outlined herein, is merely exemplary, and that the example is not intended to be independently limiting.

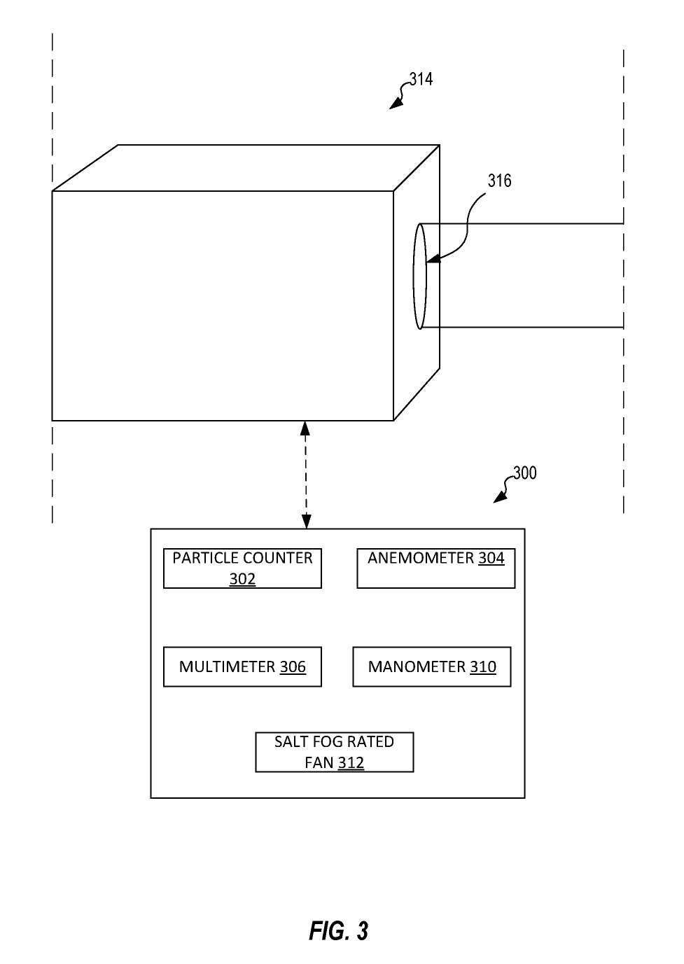

Specifically, FIG. 2 shows a spreadsheet 200 outlining the building 1 indoor quality measurements 116A, and a scorecard 214 obtained using these measurements 116A. The measurements 116A may be obtained via testing and/or manufacturer information regarding the HVAC system of the bakery 1 and the air filter associated therewith. In a presently preferred embodiment, at least some of the measurements 116A are obtained using a testing device 300 (FIG. 3).

As shown in FIG. 3, the testing device 300 may comprise one or more of a particle counter 302, an anemometer 304, a multimeter 306, a manometer 310, and a fan 312, each of which may, but need not, be an off the shelf product. The testing device 300 may be situated at or proximate a blower 314 of the HVAC system in the building 1 to test the various parameters associated therewith as outlined herein. The HVAC blower 314 may comprise an air filter 316, and the air filter 316 may be replaced with various air filters during testing to determine a preferred air filter (i.e., suggested air filter 124A (FIG. 1)).

The particle counter 302 of the testing device 300 may be, for example, a laser particle counter such as the Dylos DC1100 Pro or another particle counter, and may be used to measure the quality of air exiting the filter 316. The anemometer 304 may allow for measuring air flow across the filter 316, and may be, for example, the AAB ABM-100 airflow meter or another anemometer. The multimeter 306 may allow for measurement of electrical characteristics of the blower 314, and may, in an embodiment, be the UEI G2 Phoenix multimeter. The manometer 310 may allow the user 130 (or other personnel) to measure pressure drop across the blower 314. In an embodiment, the manometer 310 may be the MA-Line 1283B manometer. In another embodiment, the manometer 310 may be the Testo 510 manometer. In some embodiments, each of these manometers (or two or more other manometers) may be employed for redundancy. In these embodiments, the readings from the two manometers 310 may be averaged to obtain more accurate measurements. The fan 312 may be, for example, an AC fan that is used to blow air into the blower 314 for testing. The fan 312 may be a salt fog rated fan to ensure that the operation of the fan is not disturbed by the rigors of the testing. In an example embodiment, the fan 312 may be an Orion OA172SAP XC fan.

The testing device 300 may, in embodiments, have a unitary housing that houses two or more of the constituents 302-312. In other embodiments, however, each of the particle counter 302, the anemometer 304, the multimeter 306, the manometer 310, and the salt fog rated fan 312 may be a separate device having its own housing. The testing device 300 may be used to run various tests at the blower 314 of the bakery 1, the example results of which are shown in FIG. 2.

Specifically, FIG. 2 shows the spreadsheet 200 having the following columns: filter type 202 (column C1); measured air flow in cubic feet per meter 204 (column C2); the measured pressure drop across the filter 206 (column C3); the percentage of airflow with the air filter being tested versus the airflow when no filter is used 208 (column C4); the percentage of airflow of a loaded (i.e., weighted) air filter as compared to a clean air filter 210 (column C5); and, the percentage filtration efficiency with respect to particles bigger than five microns 212 (column C6). All other things being equal, a superior filter will: allow for more air flow; have a minimal pressure drop, as increase in the pressure differential indicates that the filter is becoming clogged, which puts undue stress on the HVAC system; have a relatively high airflow even when it is loaded (i.e., dirty); and/or have a high filtration efficiency, particularly with respect to particles that are five microns or greater, which may adversely affect human breathing. These factors may be given different weights depending on the environment. For example, when determining the optimal filter in a hospital environment, the filtration efficiency 212 may be given primary importance, whereas in a warehouse, more weight may be given to the filter pressure drop 206.

The rows of the spreadsheet 200 show the example results obtained at the blower 314. Specifically; the rows of the example spreadsheet 200 include: results obtained when no filter is used (row 1); results obtained when only a metal screen is used (row 2); results obtained for a clean air filter A (e.g., a filter of a first type (such as an OEM filter)) (row 3); results obtained for a clean air filter B (e.g., a filter of a second type, such as a filter having a different manufacturer, constitution, and/or MERV rating from filter A) (row 4); results obtained from a clean filter N (e.g., a filter of a third type) (row 5); results obtained when filter A is loaded (e.g., when the filter A is weighted with 20 g of flour, a substance that is commonly found in the air in the bakery 1) (row 6); results obtained when filter B is loaded with 20 g of flour (row 7); results obtained when filter N is loaded with 20 g of flour (row 8); results obtained when filter A is loaded with 40 g of flour (or with a different weight of a different substance) (row 9); results obtained when filter B is loaded with 40 g of flour (row 10); and results obtained when filter N is loaded with 40 g of flour (row 11).

For example, as shown in FIG. 2, when no filter is situated at the blower 314, the airflow across the blower 314 in cubic feet per meters as measured by the testing device 300 is 70.0 CFM (Col. 2, Row 1 (or C2, R1)), the pressure drop 206 across the filter is −0.05 (C3, R1), and the efficiency of filtration with respect to particles that are above 5 microns is nil (C6, R1) as there is no filter present in this test to filter out such particles. Alternately, when testing is conducted using filter B, the airflow is measured to be 63.9 CFM when filter B is clean (C2, R4), the pressure drop 206 across the clean filter B is −0.11 (C3, R4), the percentage of airflow with clean filter B versus no air filter 208 is 91.3% (C4, R4), and the efficiency of the unloaded filter B with respect to particles having a size of 5 microns or greater is 82.9% (C6, R4). Rows 7 and Rows 10 show example results, as measured using the testing device 300, for filter B when it is loaded with 20 g of flour and 40 g of flour, respectively.

The user 130, to determine what type of filter is optimal for building 1, may run such tests using various filters (e.g., filter A, filter B, and filter N in this example). The measurement results of the spreadsheet 200 may then be fed to the optimal filter assessor 124 (FIG. 1).

The optimal filter assessor 124 of the system 100 is a software module having machine readable instructions that can process the measurement data 116A, as shown in spreadsheet 200, to ascertain which of the tested filters is best suited for building 1. In an embodiment, the software 114 may include a graphical user interface, and the optimal filter assessor 124 may process the measurement data 116A to create therefrom a scorecard 214 for display to the user 130 (and/or an owner and operator of building 1). More specifically, the optimal filter assessor 124 may use the relative measurements obtained using the testing device 300 to attribute to each filter a point score 216. The relative point scores 216 in the scorecard 214 may be easy to understand by lay people (e.g., the point scores 216 may range from a score of 1 to 5 with 5 being the score for a theoretically ideal filter), and may allow the user 130 to conveniently illustrate the relative performance of the various filters tested to the building 1 owner or operator.

In an example embodiment, the optimal filter assessor 124 may categorize the performance of each filter tested in terms of airflow when the clean filter is used 216 (C2 of scorecard 214), airflow when the filter is loaded with a certain weight 218A (e.g., 20 g) (C3 of scorecard 214), airflow when the filter is loaded with a different weight 218B (e.g., 40 g) (C4 of scorecard 214), and the filtration efficiency 220 of each filter tested (C5 of scorecard 214). From these point scores, the optimal filter assessor 124 may also assign an overall score 222 to each filter whose performance is tested. As shown, in this example, the scorecard 214 created by the optimal filter assessor 124 may provide a convenient way for the user 130 (and/or the owner or operator of the building 1) to ascertain that filter B, having an overall score 222 of 4.5, has the highest point score 216 and is thus optimal for use in building 1 (as compared to the other filters tested). As can be seen in the measurement data 116A, filter B has the highest filtration efficiency 212 with respect to particles greater than five microns in diameter (as compared to filter A and filter N), and has the highest percentage of airflow (v. clean airflow 210) even when it is dirty (i.e., loaded with 20 g and 40 g of flour). Thus, the assessor 124 may assign the highest overall score 222 to Filter B.

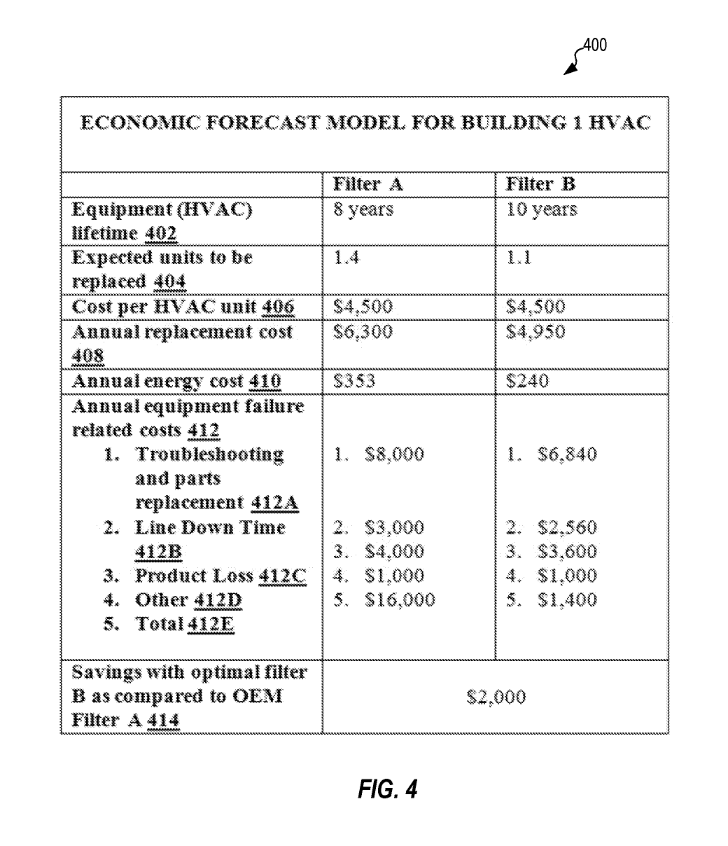

In some embodiments, a cost evaluator module 129 (FIG. 1) may evaluate costs associated with the various filters and display on the output device an economic model 400 (FIG. 4) illustrating the cost savings associated with use of the suggested filter 124A in building 1. For example, where filter A is an OEM filter currently used in building 1 and the filter assessor 124 has recommended that filter A be replaced with filter B because of the latter's superior performance, the economic model 400 may outline the savings associated with replacing filter A with filter B. In some embodiments, where the performance of two or more types of filters in building 1 (or another building), as assessed by the filter assessor 124, is generally comparable (e.g., where both have the same overall point score 222), the filter assessor 124 may recommend as the suggested filter 124A the filter which has associated therewith the lowest overall cost.

The economic model 400 may take into account and compare for each of filter A (e.g., the OEM filter) and filter B (e.g., the filter suggested by the filter assessor 124) one or more of: the HVAC equipment expected lifetime 402 in building 1 based on the HVAC systems' manufacturer specifications and the particular conditions in building 1 in which the HVAC systems operate; the expected HVAC units that will have to be replaced annually 404 based on the estimated lifetime and the current life of the HVAC units; the cost per HVAC unit 406 as outlined by the HVAC systems' manufacturer; the annual replacement cost 408 (i.e., the expected lifetime*cost per HVAC unit, e.g., $4,500*1.4=$6,300 for filter A); the annual energy costs 410; and, the annual equipment failure related costs 412, such as costs for troubleshooting and part replacement and labor 412A, the productivity losses such as line down time 412B and product loss 412C, and any other relevant considerations 412D. The annual equipment failure related costs 412 (i.e., costs 412A-412D) may be added to yield the total annual equipment failure related costs 412E.

The economic forecast model 400 generated by the software 114 may provide the owner or operator of building 1 a convenient way to compare the filters side by side in terms of overall cost of use. For example, as shown in FIG. 4, the economic model 400 may outline that recommended filter B reduces the stress on the HVAC system and thereby increases the longevity of the HVAC system as compared to filter A by two years. Upon tabulating these costs for each of filter A and filter B, the cost evaluator module 129 may outline the cost savings 414 associated with replacing the OEM filter A with the suggested filter B. For instance, the economic model 400 may provide that $2,000 in savings may result if filter A is replaced with filter B. The owner or operator of building 1 may therefore conveniently and quickly ascertain whether replacing the current filters (e.g., OEM filter A) is a worthwhile endeavor (e.g., makes business sense).

While FIG. 4 shows a comparison between filter A and filter B, the artisan will readily understand that the system 100 may likewise be used to compare the current filter with any number of other filters. In some embodiments, the economic model 400 may further outline the total cost savings associated with changing each filter in each HVAC system in the building 1.

The building 1 outdoor air quality measurements 118A (i.e., the ambient air quality conditions) may also impact operation of the building 1 HVAC systems and the selection of the optimal filter 124A therefor. As such, in some embodiments, when selecting the optimal filter 124A for building 1, the optimal filter assessor 124 may, in conjunction with the indoor air quality measurements 116A or in lieu thereof, analyze the outdoor air quality measurements 118A (FIG. 1) for building 1.

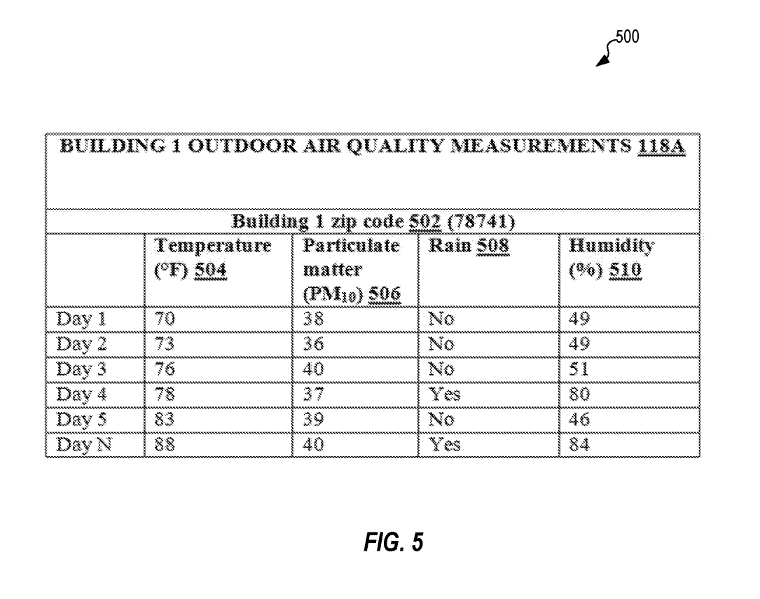

FIG. 5 shows a spreadsheet 500 illustrating an example building 1 outdoor air quality measurement data 118A stored in the outdoor air quality measurements database 118. The outdoor air quality measurements 118A may include, for example, temperature data 504, particulate matter (PM₁₀) data 506 (i.e., a measure of particles in the air that are between 2.5 to 10 micrometers in diameter, such as dust, debris, et cetera), rain data 508, humidity data 510, et cetera. At least some of the building 1 outdoor air quality measurements 118A may be obtained from publically available sources. For example, the user 130 may enter the zip code 502 of building 1 via an input device of the structure 102 and the software 114 may access over a network one or more publically available sources (e.g., websites outlining weather by zip code (such as www.weather.com), websites outlining particulate matter by zip code (such as www.airnow.gov), et cetera) periodically (e.g., once per day, once per hour, and so on) and retrieve the outdoor air quality measurement data 118A for that zip code 502 and store same in the database 118.

The optimal filter assessor module 124 may have machine readable instructions to enable the assessor 124 to account for the weather data (e.g., temperature data 504, rain data 508, humidity data 510) and pollution data (e.g., particulate matter data 506) when determining the optimal (i.e., suggested) filter 124A. For example, if building 1 is located in a first zip code and building 2 is located in a second zip code, and the particulate matter PM₁₀ of the first zip code is higher than that of the second zip code, then, all other things being equal, the optimal filter assessor 124 may select for building 1 a filter with a higher MERV rating as compared to building 2. Similarly, if the temperature 504 in the zip code 502 in which building 1 is located is generally higher than that in the zip code in which building 2 is located, the optimal filter assessor 124 may recommend that the air filter for the HVAC system of building 1 be replaced at a higher frequency than the air filter for the HVAC system of building 2, as the higher temperature may translate to heavier usage of the HVAC system in building 1 as compared to the HVAC system in building 2. Once the optimal filter 124A has been identified using the outdoor air quality measurement data 118A (and/or the indoor air quality measurement data 116A), the software 114 may create and display for the user a filter scorecard and economic forecast model such as the filter scorecard 214 and economic model 400 shown in FIGS. 2 and 4, respectively. Where the optimal filter assessor 124 uses only the building 1 outdoor air quality measurements 118A when determining the optical filter 124A (i.e., where the building indoor air quality measurements 116A are not taken into account in the calculus by the assessor 124), the need to conduct any testing via the testing device 300 may be obviated. As noted, however, it is envisioned that in embodiments, the optimal filter assessor 124 may take into account each of the indoor air quality measurements 116A and outdoor air quality measurements 118A for building 1.

In some embodiments, the memory 110 may include the filter map database 120 which may have filter map data for the buildings for which the optimal filter 124A has been determined using the system 100. For example, the filter map database 120 may have air filter maps 120A for building 1.

The artisan understands that in commercial settings, the owner or operator of a building may hire a third party to replace the air filters of all the HVAC systems associated with the building. For example, a grocery store may hire a third party to periodically replace the air filters of the HVAC systems cooling the produce sections, the bread aisles, the frozen meat sections, et cetera. These filters, because of the disparate environments in which they are located, the differing levels of use of the various HVAC systems, and the varying filter types, et cetera, may need to be replaced at different times. Even where all the air filters in a building need to be replaced at the same time, the third party technician—who may have never visited the building before—may find it cumbersome to locate all the air filters for replacement. The system 100, via the air filter map database 120, may remedy this problem.

In one embodiment, indoor positioning systems (IPS) may be used to create an air filter map of each building (e.g., a technician (or other user) 130 that visits the building 1 the first time may create the map which may be stored in the map database 120 and used by other technicians who subsequently service the building). In more detail, each location within the building (such as building 1) has a unique magnetic fingerprint that is produced by the earth's magnetic field as it interacts with steel and other materials in the building. The user 130 may use the mobile computer 128 and the mobile application 136 (e.g., a smart phone having a magnetometer and commercially available geomagnetic mapping software, such as Indoor Atlas) to create a map of the building 1, and use a graphical user interface to identify the air filters thereon. The technician who visits building 1 subsequently to replace the air filters of building 1 may access the map upon his entry to building 1 to easily navigate his way to each of the air filters in need of replacement.

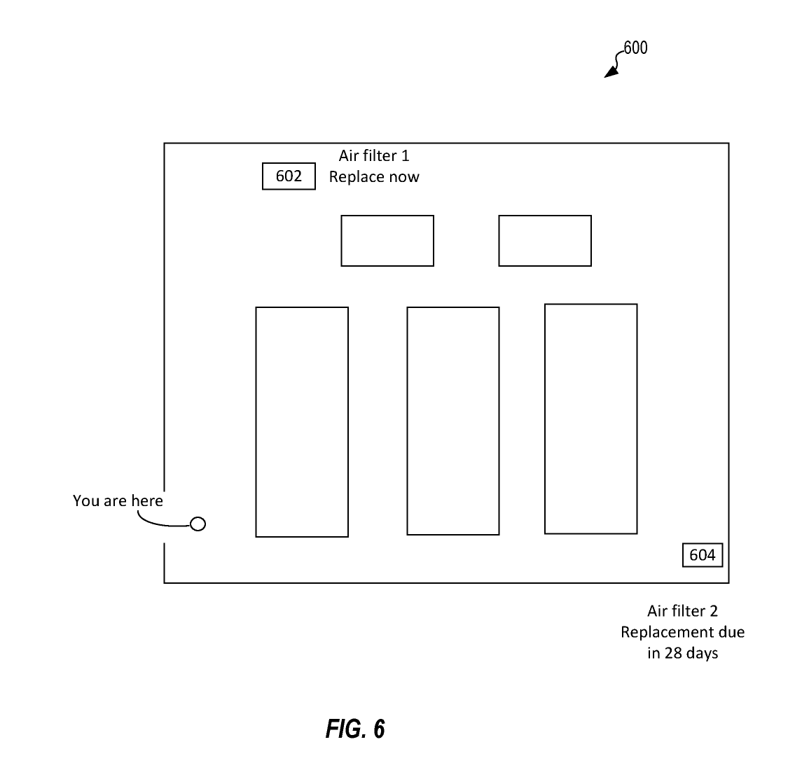

FIG. 6 shows an example map 600 for a floor of building 1, which may be stored in the filter map database 120 as building 1 filter map data 120A and may be accessed by the user 130 upon his entry into the building 1. The map 600, in conjunction with the mobile computer 128 and commercially available software (e.g., Indoor Atlas), may outline the location of all the air filters on each floor of the building 1 relative to the user 130 in real time, and thereby allow the user 130 to locate each air filter (e.g., air filters 602 and 604 on map 600 in FIG. 6) in the building 1 quickly. In some embodiments, the map 600 may include additional data. For example, the map 600 may include information outlining when a particular air filter is to be replaced, which may expedite the air filter replacement process (as the user 130 may walk only to those areas in which air filters needing replacement are located) and thereby result in cost savings. In some embodiments, the map 600 may provide other information about each filter, such as its type, manufacturer, due date for replacement, et cetera.

As noted above, the owner or operator of a building (e.g., building 1) may fail to replace the air filters associated with the HVAC systems therein because he may not be aware that one or more filters are due for replacement and/or may not have on hand the replacement filters. The system 100 may ensure that the appropriate air filters are shipped to building 1 such that the owner or operator of building 1 (and other buildings) has on hand replacement air filters when it is time to replace same. The system 100 may also send notifications to the owner or operator of building 1 to remind him that it is time to replace a particular air filter in the building.

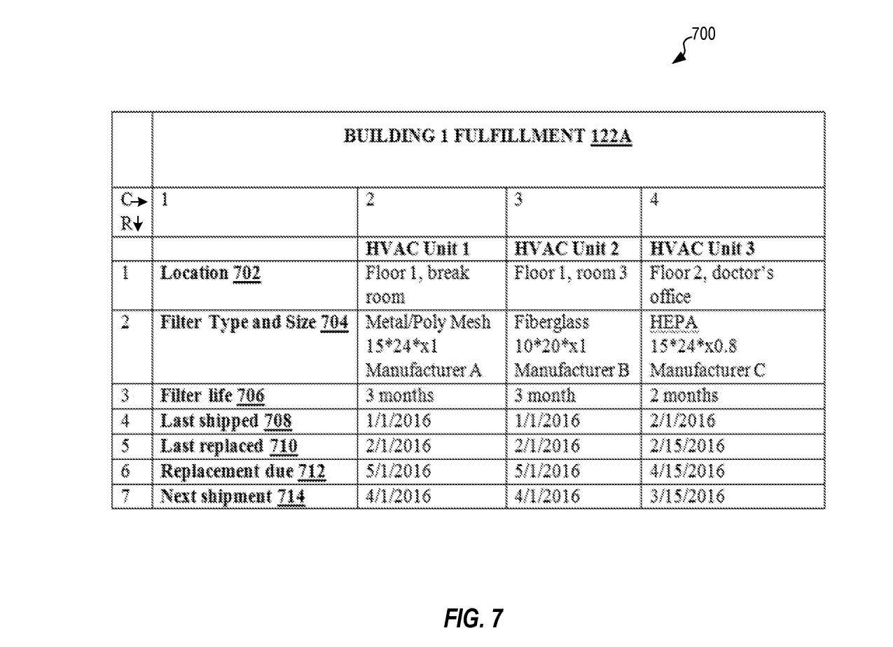

Focus is directed now to FIG. 7, which shows a spreadsheet 700 comprising the building 1 fulfillment data 122A, which may be stored in the fulfillment database 122. The building 1 fulfillment data may contain information for facilitating and ensuring timely replacement of air filters. In an embodiment, the building 1 air filter fulfillment data 122A may include location data 702, filter type and size information 704, filter life data 706, information regarding when an air filter was last shipped to building 1 708, the date on which a particular air filter was last replaced 710, the date on which the filter is next due to be replaced 712, and the date 714 on which the filter is to be shipped to building 1 to ensure that it may be timely replaced.

For illustration, consider, in this example, that building 1 has three HVAC units as set forth in columns 2, 3, and 4 of the spreadsheet 700. The location data 702 may outline where each HVAC unit is located. For example, the location data 702 may note that HVAC unit 1 is in the break room on the first floor (C2, R1), HVAC unit 2 is in room 3 on the first floor (C3, R1), HVAC unit 3 is in the doctor's office on the second floor (C4, R1), et cetera. The filter type and size data 704 may outline the type and size of each air filter associated with the particular HVAC unit. For example, the fulfillment data 122A may outline that the: HVAC unit 1 air filter is a metal and polyester mesh filter, its size is 15×24×1 inches, and that it is manufactured by manufacturer A; HVAC unit 2 air filter is a fiberglass filter, its size is 10×20×1, and it is manufactured by manufacturer B; and that the HVAC unit 3 air filter in the doctor's office is a HEPA filter, its size is 15×24×0.8 inches, and that it is manufactured by a manufacturer C.

The fulfillment data 122A may include the life 706 of each of these filters. For example, the spreadsheet 700 may outline that the life of the air filter for HVAC unit 1, 2, and 3 is three months (C2, R3), three months (C3, R3), and two months (C4, R3), respectively. In some embodiments, the filter life 706 may be the life of that air filter as set forth by the filter manufacturer. In other embodiments, the air filter life 706 may take into account the environment in which the particular air filter is located (e.g., the life 706 of two identical air filters, as set forth in the fulfillment database 122A, may be different because they are associated with HVAC units operating in differing environments). Specifically, the software 114 may estimate the life of an air filter based on the manufacturer specifications and the indoor and/or outdoor air quality measurements for the building in which the filter is located. It will be appreciated that an air filter may continue to filter air past its life (or “useful life”), but that its capacity to do so may be significantly diminished once the useful life has expired.

In some embodiments, the system 100, via the software 114 and the various databases, including the fulfillment database 122, may function as a subscription platform. Specifically, the system 100 may ensure that a new filter is shipped to building 1 such that it reaches building 1 before the replacement due date. In so doing, the system 100 may take into account the disparate lifespans of the various filters and the time at which they were last replaced. For example, as shown in FIG. 7, the system 100 may cause filters for HVAC unit 1 and HVAC unit 2 to be shipped to building 1 on Jan. 1, 2016 (C2, R4; C3, R4), and cause the filter for HVAC unit 3, which has a different lifespan, to be shipped to the building 1 on a different date (C4, R4). In some embodiments, the system 100 may notify the user 130 (or another person) that air filter(s) need to be shipped to building 1 by a date certain, and the user 130 may rely on these notifications to ensure that air filters are timely shipped. The notifications may be sent via any means (e.g., via automated text messages, e-mails, voicemails, et cetera) whether now known or subsequently developed.

In some embodiments, the system 100 may also cause a notification to be sent to the owner or operator of building 1 apprising him that a particular air filter is due for replacement. In this way, when it is time to change a particular air filter, the owner or operator of building 1 may: (a) have on hand a new replacement air filter of the proper type and size; and (b) know which air filter(s) are due to be replaced and when. In some embodiments, the system 100 may periodically send these notifications until it determines, as discussed below, that the air filter(s) have been replaced as needed. Such may facilitate the timely replacement of air filters.

While building 1 is shown in the FIG. 7 example as having three HVAC units, the artisan understands that a building, such as a commercial building, may have many (e.g., ten, fifty, hundred, et cetera) HVAC systems. Each HVAC system may have multiple air filters associated therewith. Further, as discussed above, depending on the HVAC system and the environment in which the HVAC system operates, air filters being employed in a solitary commercial (or other) building may be of several types and sizes. The task of replacing many different air filters in different portions of the commercial building may be laborious, particularly because the replacement of an air filter may require gaining access to an area that is not easily accessible (for example, a ladder and/or tools may be required to access said area to replace the air filter). As such, in commercial settings, the building owner or operator may hire a third party (e.g., an HVAC technician) to replace the air filters when their respective durations expire.

Experience has shown that these third parties are not always forthcoming in replacing the air filters. In the prior art, short of following the technician around for the duration of his visit, there is no easy way for the owner or operator of the commercial building to confirm that the air filters have been timely replaced. The third party may therefore be inclined to convey to the owner or operator (e.g., lessee) that the air filter has been replaced when it in fact has not.

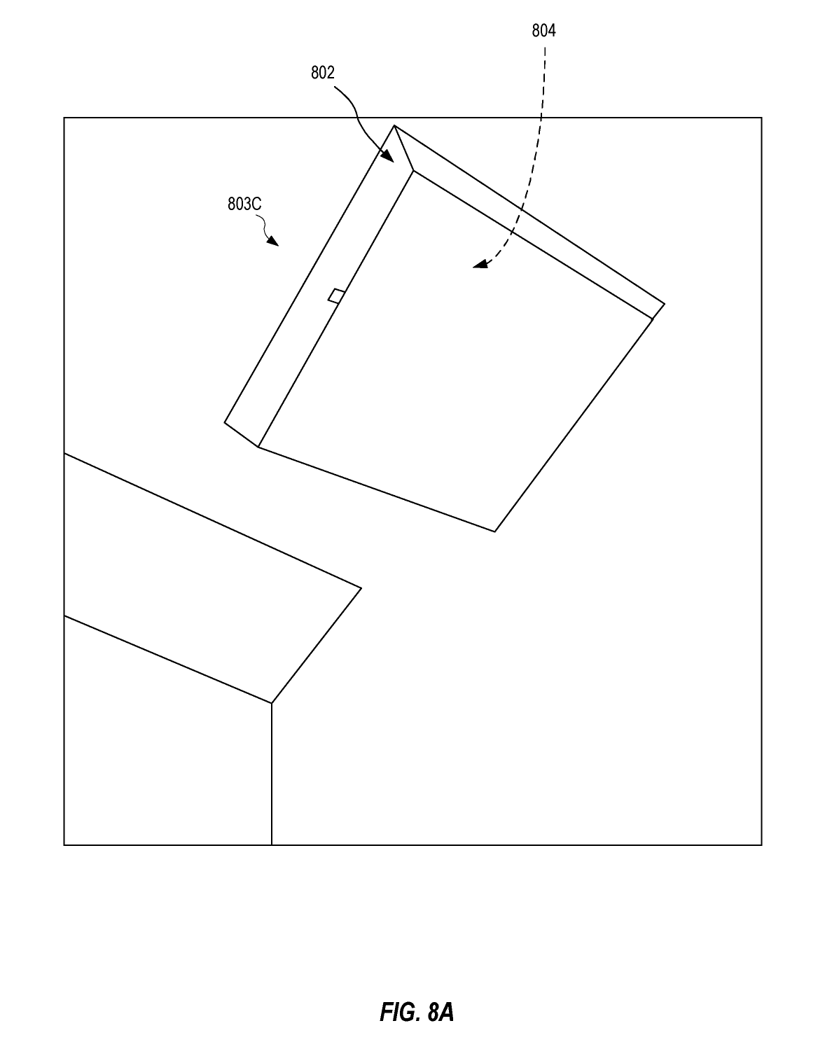

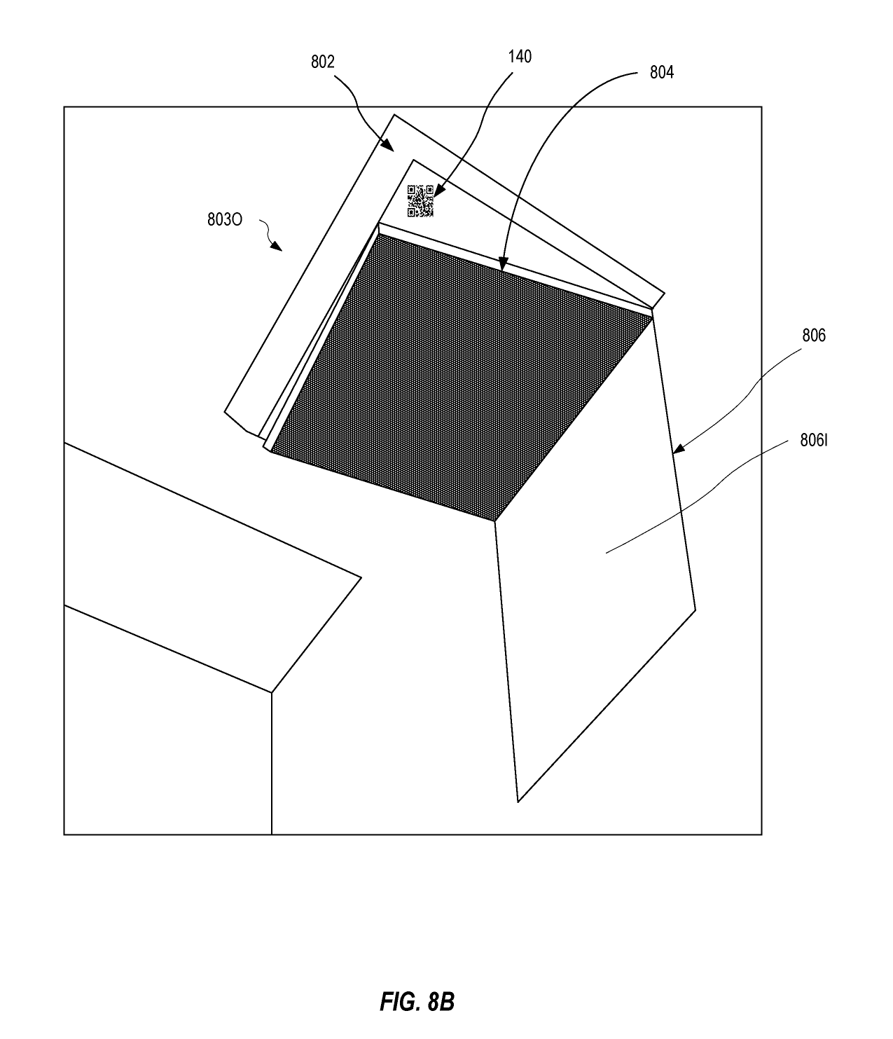

In commercial settings, hence, the barcode 140 (FIG. 1) may be employed. More specifically, the barcode 140 may be situated in the air filter booth behind the air filter such that the barcode 140 is accessible only when the air filter is removed (or at least displaced). For example, FIG. 8A shows an air filter booth 802 in a closed position 803C. While not clear from FIG. 8A, an air filter 804 is located within the booth 802. FIG. 8B shows the booth 802 in an open position 803O, and further shows that the air filter 804 has been displaced from its original position in the booth 802 when the booth 802 was in the closed position 803C. As can be seen, the barcode 140 is situated within the air filter booth 802 such that the barcode 140 is accessible only when the air filter 804 in the booth 802 is removed (or at least displaced, e.g., by unlatching the cover 806 of the booth 802). Or, for example, the barcode 140 may be situated adjacent or proximate the air filter inside a grill (or on the inside surface 806I of the cover 806) that must be opened to replace a particular air filter. A unique barcode 140 may in this way be associated with each air filter in the building 1. As discussed below, the third party may be required to scan the barcode 140 each time it replaces the air filter (e.g., the third party may be forced to remove the old air filter 804 so that it may scan the barcode 140), as the system 100 may only then deem that particular air filter (e.g., air filter 804) as having been replaced. Because the third party is required to scan the barcode 140 for the system 100 to deem that air filter as having been replaced, the third party may be dissuaded from falsely claiming that the air filter has been replaced when it has not been replaced, as the third party has to perform much of the work required to replace the air filter notwithstanding (e.g., has to set up and climb up a ladder, has to open the air filter booth cover 806, has to remove the old air filter 804 to scan the barcode 140, et cetera). Of course, if the third party fails to scan the barcode 140, a notification may be sent by the system 100 to the owner or operator of the building 1 informing him that an air filter has not been timely replaced. Thus, situating the barcode 140 in the booth 802 provides a relatively inexpensive method to ensure timely replacement of the air filter 802. The term booth or air filter booth, as used herein, encompasses any booth, compartment, closet, or other area within which an air filter associated with an HVAC system is located.

When the third party (or another person) uses the scanner 138 to scan the barcode 140 associated with a particular air filter (e.g., situated in the booth of that air filter), the system 100 may recognize that this air filter has been replaced. The system 100 may thus update the last replaced date 710. For example, as shown in FIG. 7, the fulfillment database 122 may outline that the HVAC unit 1 air filter was last replaced on Feb. 1, 2016 (C2, R5), as this was the date on which the barcode 140 associated with this air filter was last scanned. Similarly, for instance, the building 1 fulfillment data 122A may outline that the air filter for HVAC unit 3 was last replaced on Feb. 15, 2016 (C4, R5), as the barcode 140 associated with this air filter was last scanned on this date. In this way, the system 100 may provide transparency and accountability and ensure or at least facilitate the timely replacement of air filters. In addition to date (and in some embodiments, time) of scan, scanning of the barcode 140 may yield additional information that may be stored in the various databases (e.g., the type of air filter that is to be placed in that air filter booth, its manufacturer and size, et cetera). In some embodiments, the date of the scan (and other information retrieved via scanning the barcode 140) may be stored in the mobile computer 128 and be subsequently conveyed to the structure 102 (e.g., be transmitted to the structure overnight).

While not required, in some embodiments, a barcode 140′ (FIG. 1) may also be provided on each air filter (e.g., on its packaging or body) and the third party may be required to further scan this barcode 140′ when it replaces the air filter. If the scanning of the barcode 140 in the air filter booth and the barcode 140′ on the air filter indicates a disparity (e.g., that the new air filter is not a suitable replacement for the old air filter), the system 100 may notify the building 1 owner or operator (or other person, e.g., an operator of the system 100) of same in real time.

The building 1 fulfillment data 122A may also include the date 712 at which each air filter is due for replacement, and the date 714 at which the air filter is to be shipped to building 1 such that it arrives before the replacement due date 712. In setting the shipment date 714, the system 100 (e.g., the software 114) may take into account the shipping time (e.g., the system 100 may include data regarding the time it takes on average to ship air filters to the various states from the warehouse, and may take same into account when setting the next shipment dates 714 for each building).

In some embodiments, the data in the fulfillment database 122 (and in the other databases, including the indoor air quality measurement database 116, outdoor air quality database 118, and filter map database 120) may be used for analytics. Specifically, the system 100 (e.g., software 114) may have an analytics module 127 that may track the air filter preferences of the owner or operator of each building. The analytics module 127 may allow for the criteria used by the optimal filter assessor 124 in determining a suggested filter 124A to be adaptively modified. For example, where the optimal filter assessor 124 recommends a particular filter 124A for a particular building, but the owner or operator of that building ends up being dissatisfied with the suggested filter 124A, the optimal filter assessor 124 may take such into account when determining the optimal filter 124A for other similarly situated buildings. In this way, over time, the analytics module 127 may allow the system 100 to better identify those air filters that are preferred by owners or operators of similarly situated buildings (e.g., buildings having the same HVAC units, buildings located in the same zip code, building located in areas having similar weather patterns, et cetera). Such information may enable the owner or operator of the system 100 to determine trends in air filter purchase and replacement (e.g., that a particular air filter is preferred by more end users over another, or that a particular duration outlined by a filter or HVAC manufacturer is inapposite for a particular environment). The analytics information may also be used to advertise a particular air filter to potential customers, which may generate additional revenue.

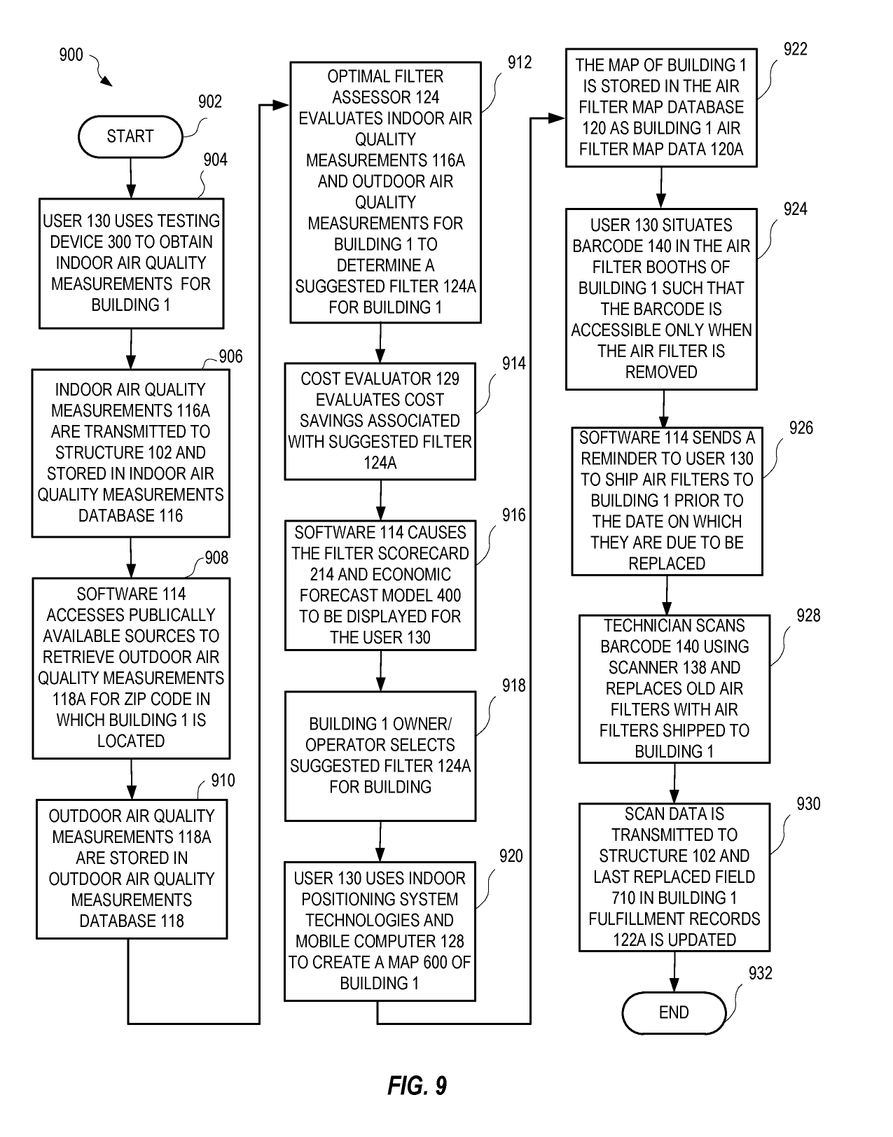

Attention is directed now to FIG. 9, which shows a method 900 of using the system 100, according to an example embodiment, to determine an optimal filter for building 1 and to facilitate timely replacement thereof. Not all steps listed in FIG. 9 need to be performed in all embodiments. The order of the steps is not intended to be independently limiting.

The method 900 may begin at step 902, and at step 904, the user 130 (FIG. 1) may use the testing device 300 (FIG. 3) to obtain indoor air quality measurements for building 1. At step 906, the user may use the mobile computer 128 (or another computer) to transmit (e.g., over the network 104) the indoor air quality measurements to the structure 102, where the indoor air quality measurements of building 1 may be stored in the indoor air quality measurements database 116 as building 1 indoor air quality measurement records 116A.

At step 908, the software 114 may access publically available sources (e.g., EPA data, commercial websites, et cetera) to collect outdoor air quality measurements for the zip code 502 (FIG. 5) in which building 1 is located. At step 910, the outdoor air quality measurements 118A for building 1 may be stored in the outdoor air quality measurements database 118.

At step 912, the optimal filter assessor 124 may evaluate the indoor air quality measurements 116A and outdoor air quality measurements 118A to determine a suggested filter 124A for building 1, as discussed above. At step 914, the cost evaluator 129 may evaluate the cost savings associated with the suggested filter 124A (as compared to the OEM filter, for example), as discussed herein. At step 916, the software 114 may cause the filter scorecard 214 outlining the point scores 216 for the suggested filter 124A (and other filters being evaluated) to be displayed for the user 130 along with the economic forecast model 400 (FIG. 4). At step 918, the owner or operator of building 1 may select the suggested filter 124A for use in the building.

At step 920, the user 130 may do a walk-through of the building 1 and, using indoor positioning system software and mobile computer 128, create a map 600 of building 1. The map 600 may include at least the location of each air filter in building 1. The map 600 may in embodiments be tied to the fulfillment database 122 and include information outlining whether a particular air filter on the map 600 is due for replacement. At step 922, the building 1 map may be stored in the air filter map database 120 as building 1 air filter map data 120A.

At step 924, the user 130 may situate unique barcodes 140 in each of the air filter booths of the air filters in building 1 such that each barcode 140 is accessible only when the air filter is removed. At step 926, prior to the time the air filters in building 1 are due for replacement, the software 114 may remind the user 130 to ship the air filters to building 1.

At step 928, when it is time to replace the air filters, a technician (or other person) may scan the barcodes 140 using the scanner 138 and replace the old air filters with the air filters that were shipped to the building 1. At step 930, the scan data obtained from the scanning of the barcode 140 may be transmitted (e.g., over the network 104) to the structure 102, and the software may cause the last replaced field 710 (FIG. 7) in the building 1 fulfillment records 122A to be updated. The method 900 may then end at step 932.

Thus, as has been described, the present disclosure may provide an easy and convenient way to determine an optimal filter for a particular application and to facilitate the timely replacement of air filters. While the invention has been highlighted using air filters, the skilled artisan will appreciate that its applicability is not so limited, and that the system 100 may be modified and employed to select and facilitate timely replacement of other consumables. Indeed, many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims.

The invention claimed is:

1. A method for ensuring timely replacement of an air filter in a building, comprising:
using a testing device to obtain an indoor air quality measurement;
employing the indoor air quality measurement to determine a preferred air filter;
situating at a booth of the air filter a barcode; the barcode being inaccessible when the booth is in a closed position;
opening the booth to expose the barcode;
scanning the barcode using a scanner prior to replacing the air filter with the preferred air filter;
receiving, over a network, data indicating the replacement of the air filter; the data including at least a date of the scan;
storing said scan date in a database; and
using computer implemented instructions to determine a shipment date based on the scan date.

2. The method of claim 1 further comprising using the computer implemented instructions to determine a replacement due date of the preferred air filter.

3. The method of claim 1 wherein the testing device includes a manometer, an anemometer, and a particle counter.

4. The method of claim 1 further comprising using the computer implemented instructions to create a filter scorecard; said filter scorecard attributing to each of the air filter and the preferred air filter a point score.

5. The method of claim 1 wherein obtaining the indoor air quality measurement comprises measuring a pressure drop across each of the air filter and the preferred air filter.

6. The method of claim 1 wherein the barcode is a quick response code.

7. The method of claim 6 wherein the quick response code is situated on a cover of the booth.

8. The method of claim 6 wherein the quick response code is situated behind the air filter such that the quick response code is inaccessible until the air filter is displaced from an original position.

9. The method of claim 6 further comprising using the computer implemented instructions to create an economic model; the economic model outlining cost savings associated with use of the preferred air filter as compared to the air filter.

10. The method of claim 1 further comprising shipping to the building a new preferred air filter by the shipment date.

11. The method of claim 10 further comprising the step of creating a map of the building; the map identifying a location of the air filter booth.

12. The method of claim 1 wherein the map further indicates a replacement due date of the air filter.

13. A method for facilitating timely replacement of a first air filter with a second air filter, comprising:
situating at an air filter booth a barcode; the air filter booth being associated with a building;
scanning the barcode using a scanner when replacing the first air filter with the second air filter;
receiving, over a network, data indicating the replacement of the first air filter;
storing said data in a database; and
using said data in said database to ship to said building a replacement air filter before said second air filter is past its useful life.

14. The method of claim 13 further comprising the step of obtaining an indoor air quality measurement to identify the second air filter.

15. The method of claim 14 wherein obtaining the indoor air quality measurement includes conducting testing with at least one loaded filter.

16. The method of claim 13 wherein the barcode is inaccessible when the booth is in a closed position.

17. A system for facilitating timely replacement of an air filter through an online structure, comprising:
a processor;
a filter assessor module for evaluating an indoor air quality measurement to determine a suggested filter;
an application programming interface for communicating with a mobile computer; the mobile computer having a barcode scanner for scanning a barcode; and
a fulfillment database;
wherein the fulfillment database is updated when the mobile computer communicates a date of the scan to the system.

18. The system of claim 17 further comprising a cost evaluator configured to create a filter economic model; the economic model delineating cost savings associated with said suggested filter.

19. The system of claim 18 further comprising a testing device to obtain the indoor air quality measurement.

20. The system of claim 19 wherein the testing device includes at least a particle counter and an anemometer.
